(19) United States
(12) Patent Application Publication
(10) Pub. No.: US 2026/0307148 A1
(43) Pub. Date: Oct. 8, 2026

(54) SILICON-BASED COMPOSITE OF SILICON-BASED PHASE COMPOSITED WITH METAL PHASES, AND PREPARATION METHOD AND USE THEREOF

(71) Applicants: XI'AN TECHNOLOGICAL UNIVERSITY, Xi'an, Shaanxi (CN); HANGZHOU XIGU TECHNOLOGY CO., LTD, Hangzhou, Zhejiang (CN)

(72) Inventors: Hongge PAN, Xi'an, Shaanxi (CN); Mingxia GAO, Xi'an, Shaanxi (CN); Wubin DU, Xi'an, Shaanxi (CN); Qinwei JIN, Hangzhou, Zhejiang (CN)

(21) Appl. No.: 18/994,128

(22) PCT Filed: Oct. 11, 2024
(86) PCT No.: PCT/CN2024/124189

§ 371 Date: Jan. 14, 2025

(30) Foreign Application Priority Data
Oct. 20, 2023 (CN) 202311364342.7

(51) Int. Cl. B22F 9/08; B22F 1/05; B22F 1/18

(52) U.S. Cl. CPC B22F 9/082; B22F 1/05; B22F 1/18; B22F 2009/0824; B22F 2009/0848; B22F 2009/086; B22F 2009/0896; B22F 2302/45; B22F 2304/058; B22F 2304/10

(57) ABSTRACT

A silicon-based composite of a silicon-based phase composited with metal phases is provided, where a silicon-based phase is assembled from silicon-based nanocrystal grains. An outer surface of the silicon-based phase is coated with the metal phases, and the metal phases form a spatial network structure by interconnecting with each other. The silicon-based phase includes a single silicon phase or a S—Ge composite phase. Under the condition that the silicon-based phase is the single silicon phase, the silicon-based nanocrystal grains are silicon nanocrystal grains, and; under the condition that the silicon-based phase is the Si—Ge composite phase, the silicon-based nanocrystal grains are Si—Ge nanocrystal grains. The metal phases each have a melting point lower than a melting point of the silicon-based phase.

### CROSS REFERENCE TO RELATED APPLICATION

The present application is a national stage application of International Patent Application No. PCT/CN2024/124189, filed on Oct. 11, 2024, which claims priority to the Chinese Patent Application No. 202311364342.7, filed with the China National Intellectual Property Administration (CNIPA) on Oct. 20, 2023, and entitled “SILICON-BASED COMPOSITE OF SILICON-BASED PHASE COMPOSITED WITH METAL PHASES, AND PREPARATION METHOD AND USE THEREOF”. The disclosure of the two applications is incorporated by references herein in their entireties as part of the present application.

### TECHNICAL FIELD

The present disclosure relates to the technical field of secondary batteries, and in particular to a silicon-based composite of a silicon-based phase composited with metal phases, and a preparation method and use thereof in a lithium-ion battery.

### BACKGROUND

With the rapid growth of economic development since the 21st century, the contradiction between energy and environment has become increasingly acute. As a next generation of “green” secondary batteries, lithium-ion batteries have been widely used in various fields such as electric vehicles, small mobile household appliance power supplies, energy storage, and electronic products. High-performance electrode materials are the key to high-performance lithium-ion batteries. As increasing requirements for high energy density and high power density of lithium-ion batteries, it is urgent to research and develop high-performance electrode materials for lithium-ion batteries. Anode materials serve as one of the key factors affecting the main performance indicators of lithium-ion batteries. Currently, graphite-based carbon anode materials used in commercial lithium-ion batteries could no longer meet the requirements of high energy density and high power density of batteries, and there is an urgent need to further develop high-performance anode materials.

In terms of anode materials for novel lithium-ion batteries, silicon (Si) anode materials have a theoretical specific capacity (in terms of the formation of a room-temperature phase Li1₅Si₄) as high as 3,579 mAh/g, which is nearly 10 times the theoretical capacity of commercial graphite-based anode materials (372 mAh/g). In addition, the Si anode material shows abundant resources and low cost, and is a highly promising next-generation high-capacity anode material. However, there are still the following major problems that restrict the large-scale commercial application of such a material. Firstly, during the process of lithium deintercalation, the silicon anode material may undergo a huge volume change (to about 300%), which could lead to material pulverization. This process reduces the electrical contact between silicon particles and causes the silicon material to peel off from a current collector, ultimately resulting in a significant reduction in cycle life. Secondly, the huge volume change of silicon materials during the cycle causes a solid electrolyte interface film (SEI film) generated by the reaction between the surface of silicon particles and the electrolyte to continuously break, such that a fresh surface of the silicon material is continuously exposed to the electrolyte, thus continuously forming new SEI film. This process not only consumes too many lithium ions in the electrolyte, but also causes uneven thickness of the SEI film, reducing coulombic efficiency, cycle, and rate performance of the battery. Thirdly, elemental silicon is a semiconductor material with low electronic conductivity, which leads to slow electrode kinetics, reduced utilization of active materials, poor high-current charging and discharging ability, and low kinetics and high rate performance.

At present, the commonly-used methods for improving the electrochemical performance of silicon-based anode materials mainly include: (1) nano-sizing, adding inert phases for lithium deintercalation and intercalation, and constructing special structures such as porous structures to reduce the expansion stress of silicon-based materials during lithium intercalation and improve the anti-pulverization ability of silicon-based materials; (2) introducing high electronic conductivity phases, such as carbon coating and introducing graphene to improve the overall electronic conductivity of silicon-based anodes; and (3) artificially prefabricating a uniform and stable SEI film to improve initial coulombic efficiency of silicon-based anode materials, reduce the irreversible loss of lithium during the cycle, and thereby improve recycle stability. However, for nano-silicon materials that could effectively reduce volume expansion during the cycle, their size is generally required to be less than tens of nanometers or even less than 10 nm.

Nanomaterials are prone to agglomeration due to the nano effect, and the anode of nanomaterials also has a low volume capacity density, while a high volume specific capacity is particularly important for practical applications. In addition, the preparation methods of nanoscale silicon-based materials and silicon-based materials with special structures such as porous structures are generally complicated, and there are also high coating process requirements for nanomaterial electrodes. Compared with nanomaterials, micron materials have high tap density, desirable specific capacity, and low preparation cost from the current practical perspective. However, the micron materials have large particle size and long lithium ion diffusion path, which are not conducive to the transport of lithium ions. As for porous materials, the porous structure with a low porosity could not effectively buffer the volume expansion of silicon-based anode materials during the lithium intercalation, while the porous structure with a high porosity reduces the volume capacity of electrodes. Processes such as carbon coating to improve the electronic conductivity of silicon-based anodes are still insufficient to maintain high conductivity of the electrode when the silicon-based anode material is severely pulverized and peeled off from the current collector, and could not effectively prevent the rapid decrease in capacity during the cycle. The preparation of artificial SEI films always requires a relatively complicated process, which is costly and inefficient. In addition, crystalline silicon-based materials are more likely to allow lithium intercalation in the <110> direction, and thus are more likely to be peeled off along the {111} plane and pulverized. Since the lithium intercalation of amorphous silicon is isotropic, a stress during the lithium intercalation is isotropic. Accordingly, compared with crystalline silicon, amorphous silicon exhibits strong resistance to pulverization during lithium intercalation and has desirable recycle performance. However, a theoretical lithium intercalation capacity of amorphous silicon is somewhat lower than that of crystalline silicon.

### SUMMARY

In view of the above problems existing in the prior art, the present disclosure provides a silicon-based composite of a silicon-based phase composited with metal phases. A lithium-ion battery assembled with the silicon-based composite as an anode shows extremely excellent rate performance and recycle stability, and has both high initial capacity and high initial efficiency.

The present disclosure adopts the following specific technical solutions:

The present disclosure provides a silicon-based composite of a silicon-based phase composited with metal phases, where a silicon-based phase is assembled from silicon-based nanocrystal grains, an outer surface of the silicon-based phase is coated with the metal phases, and the metal phases form a spatial network structure by interconnecting with each other;

the silicon-based phase includes one selected from the group consisting of a single silicon phase and a Si—Ge composite phase;

under the condition that the silicon-based phase is the single silicon phase, the silicon-based nanocrystal grains are silicon nanocrystal grains;

under the condition that the silicon-based phase is the Si—Ge composite phase, the silicon-based nanocrystal grains are Si—Ge nanocrystal grains; and the metal phases each have a melting point lower than a melting point of the silicon-based phase.

It has been characterized that under the condition that the silicon-based phase is the Si—Ge composite phase, a solid solution, or a composite phase of a Si—Ge solid solution phase and a Ge phase may be formed between Si and Ge; Si—Ge nanocrystal grains actually include Si—Ge solid solution nanocrystal grains and Ge nanocrystal grains.

In the present disclosure, the silicon-based composite achieves small volume expansion stress and strain during the lithium intercalation through advanced structural component design, thereby reducing pulverization and reducing the formation of SEI film in silicon-based anode materials during the cycle. Under conditions for improving the anti-pulverization of the silicon-based material, the formation of SEI film is reduced by using submicron-and micron-scale silicon-based anode materials and meanwhile a high tap density of the electrode material is achieved, thereby improving a volume capacity density of the silicon-based anode and the corresponding lithium-ion battery. Also, the advanced structural component design improves the electronic conductivity and lithium ion diffusion performance of the material. In this way, a silicon-based anode material with high capacity, excellent recycle stability, and desirable rate performance and a low-cost and high-yield preparation method thereof are obtained, thereby meeting the requirements for commercial use in lithium-ion batteries.

In the silicon-based composite, the silicon-based nanocrystal grains each have a dimension of 2 nm to 200 nm; the silicon-based phase has a size of 10 nm to 1,000 nm; and the silicon-based composite has a size of 200 nm to 5 μm.

In some embodiments, the silicon-based nanocrystal grains each have a dimension of 2 nm to 50 nm; the silicon-based phase has a size of 10 nm to 800 nm; and the silicon-based composite has a size of 300 nm to 3 μm.

In some embodiments, the silicon-based nanocrystal grains each have a dimension of 2 nm to 30 nm; the silicon-based phase has a size of 30 nm to 300 nm; and the silicon-based composite has a size of 300 nm to 1.5 μm.

In the present disclosure, the metal phases each have a limited melting point: under the condition that the silicon-based phase is the single silicon phase, the metal phases each have a melting point lower than a melting point of silicon; and under the condition that the silicon-based phase is the Si—Ge composite phase, the metal phases each have a melting point lower than a melting point of the Si-Ge composite phase.

Experiments have found that when the metal phases each have a melting point higher than that of the silicon-based phase, such as Cr as the metal, a Cr phase or Cr-containing conductive network could not be formed on the outer surface of the silicon-based phase, and thus could not play a role in improving the electrochemical performance of the silicon anode material.

In some embodiments, a metal in the metal phases is at least one selected from the group consisting of Sn, In, Al, Pb, Zn, Sb, Bi, Se, and Ag.

In some embodiments, a temperature difference AT in a melting point between the metal phases and the silicon-based phase is not less than 500° C.

Further experiments revealed that when the temperature difference in a melting point between the metal phases and the silicon-based phase is less than 500° C, a network structure could not be fully formed to exert its conductive network structure and cover Si particles, thereby weakening a role in improving the electrochemical properties of Si-based materials.

In some embodiments, the metal is at least one selected from the group consisting of Sn and In, and preferably is Sn.

In some embodiments, the silicon-based phase is the Si—Ge composite phase. Experiments have shown that under the condition that Ge is added, the prepared silicon-based nanocrystal grains have a lower dimension, a carrier concentration of the composite is greatly improved, and the dimension of the assembled silicon-based phase is also lower. Therefore, the composite finally prepared has better overall electrochemical properties, especially better recycle stability at a high current density.

The present disclosure further provides a method for preparing the silicon-based composite of the silicon-based phase composited with the metal phases, including the following steps:

step 1, uniformly mixing a silicon-based raw material and a metal raw material, and subjecting a resulting mixture to suspension induction melting in an argon atmosphere to obtain a silicon-based composite ingot; where the silicon-based raw material is selected from the group consisting of Si and a mixture of Si and Ge;

the metal raw material is at least one selected from the group consisting of Sn, In, Al, Pb, Zn, Sb, Bi, Se, and Ag;

step 2, crushing the silicon-based composite ingot into a powder, placing the powder in a vacuum rotary quenching furnace, and subjecting the powder therein to suspension melting in an argon atmosphere; transferring a resulting melt through a nozzle carrying an argon gas flow, and then spray-casting the resulting melt onto a high-speed rotating copper roller, and then cooling to collect a resulting rapidly-quenched product; and step 3, subjecting the rapidly-quenched product to sand-milling to obtain the silicon-based composite of the silicon-based phase composited with the metal phases.

In the present disclosure, the method includes suspension melting, rapid quenching, and sand-milling, all of which are mature industrial preparation methods with desirable controllability of preparation process parameters, low cost, and high yield, and are suitable for commercial production. Raw materials of the metal phases and their amounts are optimized, and Ge is added to the silicon material, and then the rapid quenching and parameters thereof are adjusted to achieve the effect of adjusting the Si-based phase performance (including adjustment on the particle size of Si-based phase and the grain size of silicon-based nanocrystal grains constituting the Si-based phase). The present disclosure provides a silicon-based composite formed by compositing the metal with silicon-based phases of different particle sizes and nanocrystal grains of different grain sizes in the silicon-based phase.

In step 1, a molar ratio of the silicon-based raw material to the metal raw material is in a range of 1:(0.01-0.3). In some embodiments, under the condition that the silicon-based raw material is the mixture of Si and Ge, a molar ratio of Si to Ge is in a range of 1:(0.01-0.5).

In some embodiments of the present disclosure, a molar ratio of the silicon-based raw material to the metal raw material is in a range of 1:(0.03-0.11), preferably 1:(0.03-0.08), and more preferably 1:0.05.

Experiments have found that by adjusting the molar ratio of silicon-based raw material to the metal raw material, the grain size of silicon-based nanocrystal grains and the partcile size of the silicon-based phase could be adjusted, thereby adjusting the carrier mobility and exchange current density of the composite. Further, with the continuous optimization of the molar ratio of the above silicon-based raw material to the metal raw material, the prepared composite has better electrochemical properties.

In some embodiments, the silicon-based raw material is a mixture of Si and Ge. In some embodiments, a molar ratio of Si to Ge is in a range of 1:(0.03-0.12), preferably 1:(0.03-0.08), and more preferably 1:(0.05-0.06).

Experiments have found that by adjusting the molar ratio of Si to Ge, the grain size of silicon-based nanocrystal grains and the particle size of the silicon-based phase could be adjusted, thereby adjusting the carrier mobility and exchange current density of the composite. Further, with the continuous optimization of the above molar ratio of Si to Ge, the prepared composite has better electrochemical properties.

In some embodiments, in step 2, the argon gas flow has a pressure of 0.4 to 4.0 atmospheres;
the high-speed rotating copper roller has a linear speed of 10 m/s to 100 m/s; and
the spray-casting is conducted at a distance of 0.5 m to 2.5 m.

Experiments have found that the grain size of silicon-based nanocrystal grains and the particle size of silicon-based phase in silicon-based composite could also be controlled by regulating the pressure of the sprayed argon gas flow for the spray-casting and the rotational linear speed of the copper roller.

In some embodiments, the argon gas flow has a pressure of 1.5 to 3.0 atmospheres; and the high-speed rotating copper roller has a linear speed of 25 m/s to 60 m/s.

In some embodiments, the argon gas flow has a pressure of 1.7 to 2.5 atmospheres; and the high-speed rotating copper roller has a linear speed of 30 m/s to 40 m/s.

The present disclosure further provides use of the silicon-based composite of a silicon-based phase composited with metal phases in preparation of a lithium-ion battery.

Specifically, the silicon-based composite used as an anode; a conventional cathode material for lithium-ion battery being adopted as a cathode, such as LiFePO₄, LiCoO₂, and a ternary material; a separator and an electrolyte conventionally used in commercial lithium-ion batteries are used to assemble the lithium-ion battery.

Compared with the prior art, some embodiments of the present disclosure have the following advantages:
1. In the silicon-based composite disclosed in the present disclosure, silicon particles constituting the silicon-based phase each have a particle size mainly in the range of tens of nanometers to submicron scales. In addition, the silicon-based phase is composed of smaller Si nanocrystal grains with a dimension of mainly several nanometers to tens of nanometers or a small amount of amorphous Si. In the lithium intercalation of the composite, a large number of silicon-based nanocrystal grains with different arrangement directions actually form isotropic stress strain, and the silicon particles constituting the silicon-based phase have high strain resistance, thereby greatly improving the anti-pulverization ability of the silicon-based composite and effectively improving the recycle performance of the composite. In addition, the metal phases with a spatial network structure coated between the silicon particles constituting the silicon-based phase not only has high electronic conductivity, which greatly improves the overall electronic conductivity of the silicon-based composite, but also buffers the volume expansion of the silicon particles constituting the silicon-based phase to a certain extent, thus further improving the anti-pulverization ability of the composite and further improving the recycle stability of the composite. The fine silicon-based phase also greatly shortens a diffusion distance of lithium ions, which is beneficial to improving the kinetic properties of silicon-based anode materials and obtaining excellent rate performance.
2. In the silicon-based composite disclosed in the present disclosure, when Sn and In exists as composite phases, the Sn and In themselves are reversible lithium intercalation and deintercalation materials, and their theoretical lithium intercalation capacities are 994 mAh/g and 700 mAh/g, respectively. The silicon-based composite disclosed herein could not only serve as a conductive network, but also act as an active material. In addition to contributing to capacity, its network structure in the composite also facilitates the migration of lithium ions in the silicon-based phase. This further ensures the high capacity and excellent rate performance of the composite.
3. In the composite disclosed in the present disclosure, Ge is introduced into the Si-based phase. Ge itself is also a lithium intercalation material and has a lithium intercalation capacity of about 1,623 mAh/g in terms of Li₂₂Ges. Although being lower than that of Si, the electronic conductivity of Ge is about 4 orders of magnitude higher than that of Si, and its hole mobility is more than 4 times that of Si, which is conducive to the rapid transmission of lithium ions. The introduction of Ge is conducive to the improvement of the kinetic performance of silicon-based composite as the anode material, thereby improving the rate performance. After Ge and Si form a solid solution, the interplanar spacing of Si becomes larger, which is conducive to the intercalation and deintercalation of lithium ions, which is also conducive to the transmission of lithium ions in Si. However, the volume expansion of Ge during lithium intercalation is as high as about 200%. However, in the composite disclosed in the present disclosure, since the Si—Ge phase formed is in size of tens of nanometers to hundreds of nanometers, and further, the Si—Ge phase is composed of nanocrystal grains with a size from several nanometers to tens of nanometers, the stress-strain ability of the Si—Ge phase to resist volume expansion during lithium intercalation is greatly improved. This effectively improves the volume expansion problem that also exists in Ge during lithium intercalation, and the ability of composite to resist pulverization during cycle is greatly improved. Further, in combination with its high carrier mobility and excellent lithium ion transmission ability, the composite anode material composed of Si—Ge phase and metal phases has excellent recycle stability, especially high-rate recycle performance. Moreover, due to the large specific gravity of Ge, the tap density of the composite is high, which is beneficial to the improvement of the volume density of electrodes and batteries.
4. When the silicon-based composite disclosed in the present disclosure is compounded with other metals except aluminum, the tap density of the composite is much higher than the tap density of the silicon material since the other metals have a large atomic number and a high density. As an anode material for lithium-ion batteries, the volume capacity density of the corresponding lithium-ion battery is greatly improved, which is highly important for the practical application of lithium-ion batteries.
5. If the silicon-based composite disclosed herein uses a non-lithium-deintercalation active metal, the metal coating of the silicon-based phase could further reduce the interface reaction between the Si-based phase and the electrolyte, and further improve the initial coulombic efficiency of the material.
6. The preparation process of the silicon-based composite disclosed in the present disclosure adopts the methods of suspension melting, rapid quenching, and sand-milling, which are all industrialized preparation methods. The preparation methods are mature, have desirable process controllability, low cost, and high yield, and are environmentally friendly and suitable for large-scale production.
7. When the silicon-based composite disclosed in the present disclosure is used as the anode material of a lithium-ion battery, the particle size of a rapidly-quenched product is refined by sand milling, and the sand milling is highly efficient and takes a short time. The obtained composite has a particle size ranging from several hundred nanometers to 2-3 micrometers. Compared with nanomaterials with a particle size of several nanometers to tens of nanometers, the composite has a smaller specific surface area, a larger tap density, and a simple electrode preparation operation. In addition, due to the small specific surface area of the composite, there are less interfacial reaction between the composite and the electrolyte, and thereby the composite achieves high initial coulombic efficiency. Moreover, since the metal material covers the Si-based phase, the contact between the silicon-based composite and the electrolyte interface is further reduced and the formation of the SEI film is reduced, which is beneficial to improving the coulombic efficiency of the silicon-based composite as an anode material during the cycle.
8. In the present disclosure, a silicon-based composite of a silicon-based phase composed of nanocrystalline grains or a small amount of amorphous components and composited with metal phases is obtained by optimizing the selection of raw materials and the preparation process. The metal does not form an alloy phase or a solid solution phase with Si or Si—Ge phase. Since the melting point of the selected metal is lower than that of the Si material, or the melting point of the selected metal is lower than that of the Si—Ge phase when the Si-based phase is the Si—Ge phase, the Si phase or Si—Ge phase solidifies first during the rapid quenching. The low-melting metal phases solidify in the gaps between phase particles of Si or Si—Ge after the Si phase or Si—Ge phase solidifies, covers the surface of the silicon-based phase, and connects with each other to form a metal network structure. Since metal has high electrical conductivity, the metal network structure greatly improves the electronic conductivity of the silicon-based composite. By regulating and optimizing the content of the metal phases, its electronic conductivity could reach a value several orders of magnitude larger than that of Si-based material to obtain high carrier mobility and high exchange current density, thereby effectively improving the comprehensive electrochemical performance of silicon-based composite as an anode material for lithium-ion batteries.

### BRIEF DESCRIPTION OF THE DRAWINGS

FIG. 1 shows a metallographic photograph of the ingot prepared in step 1 of Example 1.

FIG. 2A shows a scanning electron microscopy (SEM) morphology image of the rapidly-quenched product prepared in step 2 of Example 1, and FIG. 2B shows a backscattered electron (BSE) morphology image of the rapidly-quenched product prepared in step 2 of Example 1.

FIG. 3A shows an X-ray diffraction (XRD) pattern of the silicon-based composites prepared in Examples 1 to 3, respectively, and FIG. 3B shows an SEM morphology image of the silicon-based composite prepared in Example 1.

FIG. 4A shows an SEM morphology image of the rapidly-quenched product prepared in step 2 of Example 2, and FIG. 4B shows a BSE morphology image of the rapidly-quenched product prepared in step 2 of Example 2, and FIG. 4C shows an SEM morphology image of the finally prepared silicon-based composite.

FIG. 5 shows a BSE morphology image of the rapidly-quenched product prepared in step 2 of Example 3.

FIG. 6A to FIG. 6D show recycle performance curves of lithium-ion batteries assembled with the silicon-based anode materials prepared in Examples 1 to 3 at a current density of 300 mA/g (FIG. 6A), 1,500 mA/g (FIG. 6B), and 15,000 mA/g (FIG. 6C); and capacity curves (FIG. 6D) thereof at different current densities (mA/g).

FIG. 7A shows an SEM morphology image of the silicon-based composite finally prepared in Example 4, and FIG. 7B shows a transmission electron microscopy (TEM) morphology image of the silicon-based composite finally prepared in Example 4.

FIG. 8 shows a TEM morphology image of the silicon-based anode material prepared in Example 5.

FIG. 9A shows an SEM morphology image of the rapidly-quenched product prepared in step 2 of Example 6, and FIG. 9B shows a TEM morphology image of the finally prepared silicon-based composite.

FIG. 10A shows an SEM morphology image of the silicon-based composite finally prepared in Example 7, and FIG. 10B shows a TEM morphology image of the silicon-based composite finally prepared in Example 7.

FIG. 11 shows XRD patterns of the silicon-based composites prepared in Examples 4 to 7, respectively.

FIG. 12A to FIG. 12D show recycle performance curves of lithium-ion batteries assembled with the silicon-based composites prepared in Examples 4 to 7 at a current density of 300 mA/g (FIG. 12A), 1,500 mA/g (FIG. 12B), and 15,000 mA/g (FIG. 12C), and capacity curves (FIG. 12D) thereof at different current densities (mA/g).

FIG. 13 shows an XRD pattern of the silicon-based composite prepared in Example 9.

FIG. 14A to FIG. 14D show recycle performance curves of lithium-ion batteries assembled in Example 9 at a current density of 300 mA/g (FIG. 14A), 1,500 mA/g (FIG. 14B), and 15,000 mA/g (FIG. 14C), and capacity curves (FIG. 14D) thereof at different current densities (mA/g).

FIG. 15A shows an SEM image of the rapidly-quenched products prepared in step 2 of Example 11, and FIG. 15B shows an SEM image of the rapidly-quenched products prepared in step 2 of Example 13.

FIG. 16A shows XRD patterns of the silicon-based composites prepared in Examples 10 to 13, respectively, and FIG. 16B shows an enlarged view of the diffraction peak of the (422) crystal plane of Si.

FIG. 17A shows an SEM morphology image of the silicon-based composite prepared in Example 11 and FIG. 17B shows a TEM morphology image of the silicon-based composite prepared in Example 11, and FIG. 17C shows a TEM morphology image of the silicon-based composite prepared in Example 13.

FIG. 18A to FIG. 18D show recycle performance curves of batteries assembled in Example 10 to 13 at a current density of 300 mA/g (FIG. 18A), 1,500 mA/g (FIG. 18B), and 15,000 mA/g (FIG. 18C), and capacity curves (FIG. 18D) thereof at different current densities (mA/g).

FIG. 19A and FIG. 19B show SEM morphology images of the final products prepared in Comparative Example 1 (FIG. 19A) and Comparative Example 2 (FIG. 19B), respectively.

FIG. 20A to FIG. 20D show recycle performance curves of batteries assembled in Comparative Examples 1 to 2 at a current density of 300 mA/g (FIG. 20A), 1,500 mA/g (FIG. 20B), and 15,000 mA/g (FIG. 20C); and capacity curves (FIG. 20D) thereof at different current densities (mA/g).

FIG. 21 shows an XRD pattern of the silicon-based composite prepared in Comparative Example 3.

FIG. 22 shows a BSE morphology image of the silicon-based composite prepared in Comparative Example 3.

FIG. 23A to FIG. 23D show an energy dispersive spectrometry (EDS) pattern of the silicon-based composite prepared in Comparative Example 3.

FIG. 24 shows a recycle performance curve of the battery assembled in Comparative Example 3 at a current density of 300 mA/g.

### DETAILED DESCRIPTION OF THE EMBODIMENTS

Specific embodiments of the present disclosure will be further described below in conjunction with examples. It should be noted that the specific embodiments described here are only for illustrating and explaining the present disclosure, and are not intended to limit the scope of the present disclosure.

### Example 1

Step 1: a total of 100 g of silicon (Si) blocks (mass purity greater than 99.9 %, the same below) and indium (In) powder (greater than 99.9 wt %) were weighed at a molar ratio of 95:5, put into a graphite crucible, and subjected to suspension induction melting under argon protection. The suspension induction melting was conducted at a power of 15 kW for 5 min. An ingot was obtained after the melting.
Step 2: The ingot was mechanically crushed, a resulting powder sample was placed in a quartz tube. The quartz tube was placed in a vacuum rotary quenching furnace. A furnace chamber was first vacuumized, argon gas was then introduced thereto to 0.5 atmospheres, and suspension melting was conducted for 5 min. After the melt was completely melted, it was spray-casted onto a high-speed rotating copper roller through a nozzle with an argon gas flow of 2.5 atmospheres to allow rapid cooling, where a linear speed of the rotating copper roller was 40 m/s and a spray-casting distance was 2 m. After cooling, a rapidly-quenched product was collected and recorded as a Si/5 at % In (at % referring to atomic percentage) composite.
Step 3: The rapidly-quenched product was ground with a sand mill. The grinding was conducted with anhydrous ethanol as a grinding medium using zirconium oxide grinding beads at a rotation speed of 1,500 rpm for 25 min in the sand milling. After drying, a Si-composited-with-In silicon-based composite was obtained.

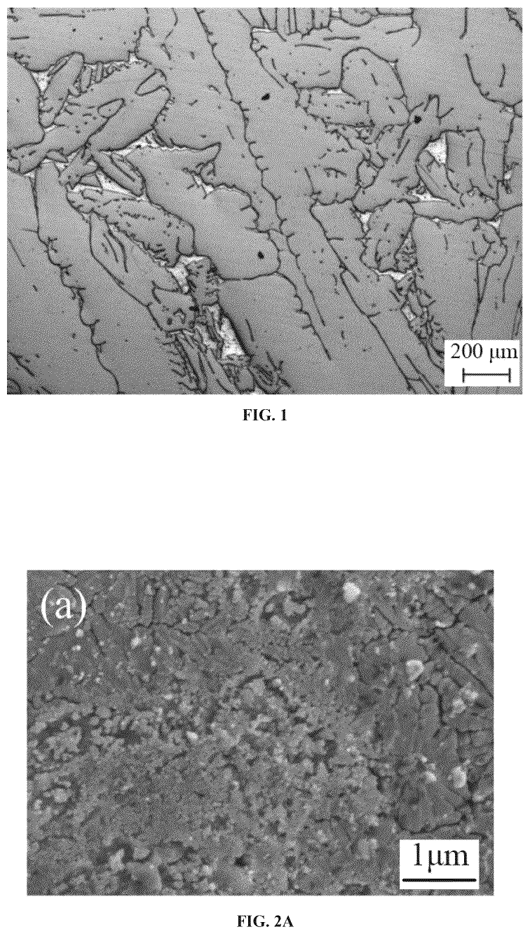

FIG. 1 shows a metallographic photograph of the ingot prepared in step 1 of this example. The product consisted of a coarse Si phase (dendritic crystal phase in FIG. 1) with a size of (200-1,000) μm and an In phase between the Si phases.

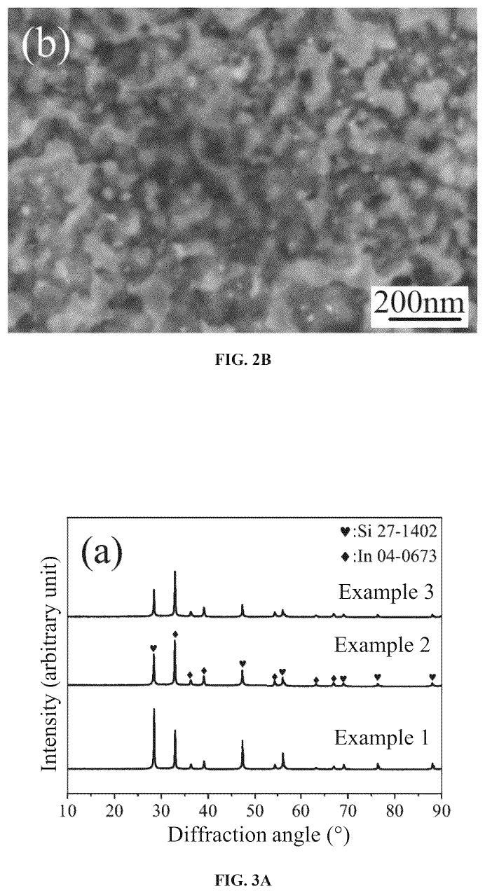

FIG. 2A shows an SEM morphology image of the Si/5 at % In composite prepared in step 2 of this Example and FIG. 2B shows a BSE morphology image of the Si/5 at % In composite prepared in step 2 of this Example. It is observed that the surface is not dense in FIG. 2A, which might be due to the low melting point of In and volatilization in a small amount occurs during the rapid quenching. It is observed that the dark phase is the Si phase, and the light phase is the In phase in FIG. 2B. The Si phase in the composite has a particle size mainly of 30 nm to 80 nm. The Si phase is surrounded by the In phase, and the In phase forms a network structure by interconnecting between the Si phases. The In network structure with high electronic conductivity greatly improves the electronic conductivity of the Si/In composite.

It should be noted that due to the high volatility of In, which might damage the instrument, the In-containing composite could not be further observed by TEM for the crystallization of Si phase particles, and the dimension of nanocrystal grains in Si phase particles could not be seen. However, since the particle size of Si phase particles was only 30 nm to 80 nm, the dimension of the crystal grains that make up the particles was smaller than the particle size. In the following examples, the grain size of Si nanocrystal grains in the In-containing composite could not be characterized. With reference to the grain sizes of other examples, the Si phase in the In-containing composite should be composed of nanocrystal grains of similar size, which are all smaller than the single Si phase.

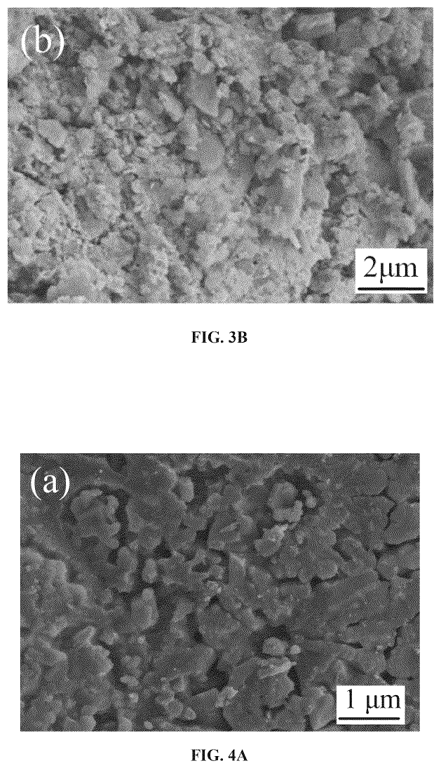

FIG. 3A shows an XRD pattern of the silicon-based composite finally prepared in this example. XRD detection shows that the composite only contains Si (JCPDS27-1402) and In (JCPDS 04-0673) phases, and no other phases are detected, indicating that Si and In do not form an alloy phase during the preparation process. FIG. 3B shows the SEM morphology image of the silicon-based composite finally prepared in this example. The particle size of the composite is mainly of 300 nm to 1 μm, and a small amount of particles are 1-2 μm in size, indicating that the particle morphology of the composite is typical mechanically-crushed morphology.

The tap density of the silicon-based composite prepared in this example was tested (using a 5 mL measuring cylinder, a vibration frequency of 250 times/min, an amplitude of 3 cm, and the number of vibration being 3,000 times), and its tap density was 0.81 g/mL, which was much higher than 0.65 g/mL of the product prepared in Comparative Example 1 and 0.66 g/mL of the product prepared in Comparative Example 2.

The conductivity of the silicon-based composite prepared in this example was tested using a four-probe tester, and its electronic conductivity was as high as 27.3 S/cm, which was nearly 6 orders of magnitude higher than the electronic conductivity of the silicon-based materials prepared in Comparative Examples 1 and 2. The carrier mobility of the silicon-based composite prepared in this example was tested by the Hall effect to be 1,208 cm 2/(V·s), which was increased by about 1,000 times and 600 times compared with the carrier mobility of the silicon-based materials prepared in Comparative Examples 1 and 2, respectively. In addition, the exchange current density of the silicon-based composite prepared in this example was tested by a symmetrical cell linear potential scanning method to be 3.9mA/cm², which was increased by more than 3 orders of magnitude compared with the products of Comparative Examples 1 and 2. High electronic conductivity, carrier mobility, and exchange current density are extremely beneficial and effective for improving the utilization, recycle performance, and rate performance of silicon-based active materials.

### Example 2

In this example, the preparation process was substantially the same as that of Example 1, except that in step 1, a total of 100 g of the Si block and In powder were weighed at a molar ratio of 90:10.

The XRD pattern of the silicon-based composite finally prepared in this example is also shown in FIG. 3A. XRD detection shows that the composite only contains Si and In phases, and no other phases are detected, indicating that Si and In do not form an alloy phase.

FIG. 4A shows an SEM morphology image of the rapidly-quenched product (denoted as Si/5 at % In composite) prepared in step 2 of this example, and FIG. 4B shows a BSE morphology image of the rapidly-quenched product (denoted as Si/5 at % In composite) prepared in step 2 of this example, and FIG. 4C shows an SEM morphology image of the finally prepared product. FIG. 4A shows that the porosity on the surface of the rapidly-quenched product is greater than that of Example 1. FIG. 4B shows that the positional states of the Si phase and the metal In phase are similar to those in Example 1, but the particle size of the Si phase was mainly 30 nm to 100 nm, which is slightly larger than that of Example 1. FIG. 4C shows that the particle size of the silicon-based composite is substantially at 300 nm to 1 μm, and a small amount of particles are sized at 1-2 μm, and that the particle morphology of the composite is typical mechanically-crushed morphology.

By tests, the silicon-based composite prepared in this example had a tap density of 0.79 g/mL and an electronic conductivity as high as 714.3 S/cm, and achieved a carrier mobility and an exchange current density of 566.5cm² /(V·s) and 1.701 mA/cm² , respectively.

### Example 3

In this example, the preparation process was substantially the same as that of Example 2, except that in step 2:

After the melt was completely melted through suspension melting, it was spray-casted onto a high-speed rotating copper roller through a nozzle with an argon gas flow of 1.5 atmospheres to allow rapid cooling, where a linear speed of the rotating copper roller was 25 m/s and a spray-casting distance was 2 m.

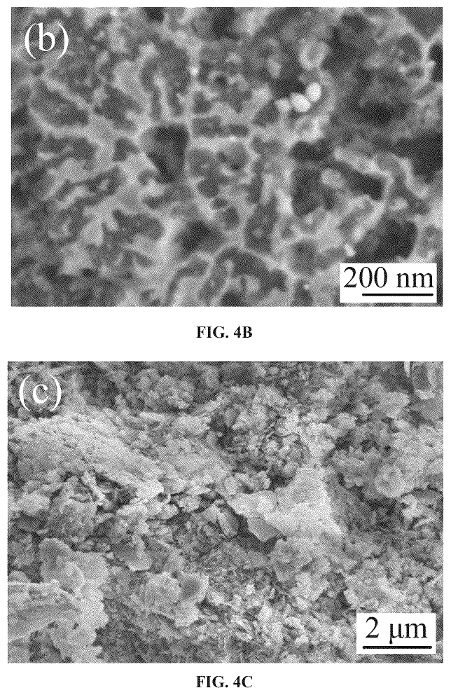

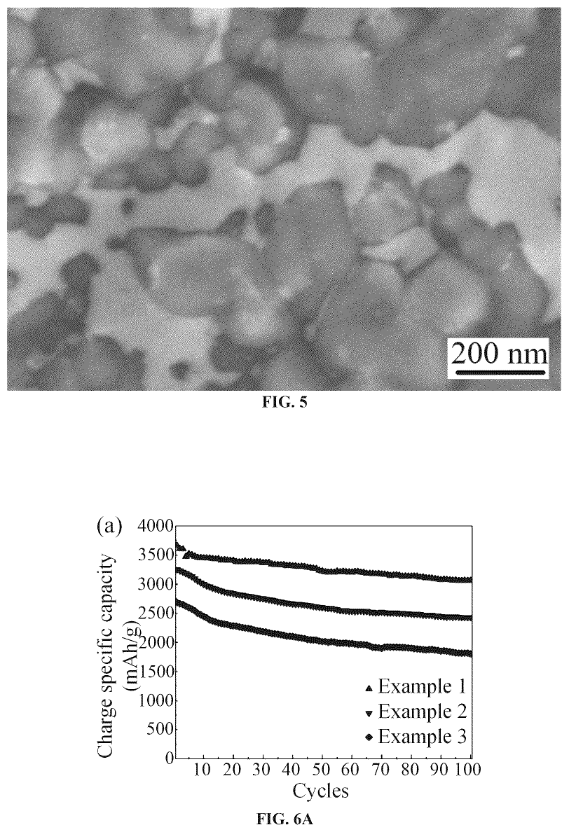

FIG. 5 shows a BSE morphology image of the rapidly-quenched product prepared in step 2 of this example. It is found that the positional states of the Si phase and the metal In phase are similar to those in Example 1, but the particle size of the Si phase particles is mainly at 100 nm to 300 nm, which is significantly larger than those of the rapidly-quenched products prepared in Examples 1 and 2, respectively. This is mainly due to the reduction in the linear speed of the rotating copper roller and the argon gas flow in the nozzle.

By tests, the silicon-based composite prepared in this example had a tap density of 0.78 g/mL and an electronic conductivity of 701 S/cm, and achieved a carrier mobility and an exchange current density of 171 cm² /(V·s) and 0.65 mA/cm² , respectively.

### Performance Testing

The Si/In composites prepared in Examples 1 to 3 were used to prepare anode sheets, respectively, and separately assembled into batteries, and the electrochemical properties of the batteries and electrodes were tested as follows:

When preparing the anode of the lithium-ion battery, a sand-milled product (Si/In composite) that had not been dried in step 3 was directly mixed with a conductive agent acetylene black (the conductive agent was added in an amount of 20% of the weight of the Si/In composite), a resulting mixture was subjected to sand milling for 5 min (rotation speed of a sand mill being 500 rpm), and a resulting mixed slurry was dried and directly used as the anode material.

The anode material and a sodium alginate aqueous binder (concentration: 3 wt %) were uniformly mixed at a mass ratio of 83:17. The mixed slurry was applied onto a copper current collector, dried in an oven, and then compacted at a pressure of 12 MPa for 30 s to form an electrode sheet. The electrode sheet was punched into a disc with a diameter of 10 mm. A CR2025 button cell was assembled with a lithium sheet as a counter electrode, and the electrochemical performance of the electrode sheet was tested. The cell assembly was done in an argon-filled glove box. The Celgard-2400 type separator specially used for lithium-ion batteries was adopted as the separator. With LiPF₆ as a solute, an electrolyte with a concentration of 1 mol/L was prepared by using ethylene carbonate (EC), dimethyl carbonate (DMC), and diethyl carbonate (DEC) at a mass ratio of 1:1:1 as a mixed solvent, and adding 10 wt % of fluoroethylene carbonate (FEC) as an additive. The specific capacity, recycle performance (where activation was conducted three times at current densities of 150 and 300 mA/g respectively, before recycle performance test at current densities of 1,500 mA/g and 15,000 mA/g), and rate performance of the electrode were tested on an electrochemical tester using a constant current test with a voltage window of 0.01 V to 1.5 V.

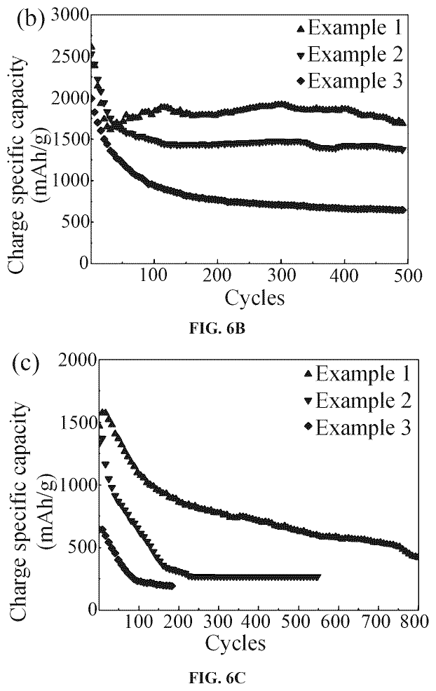

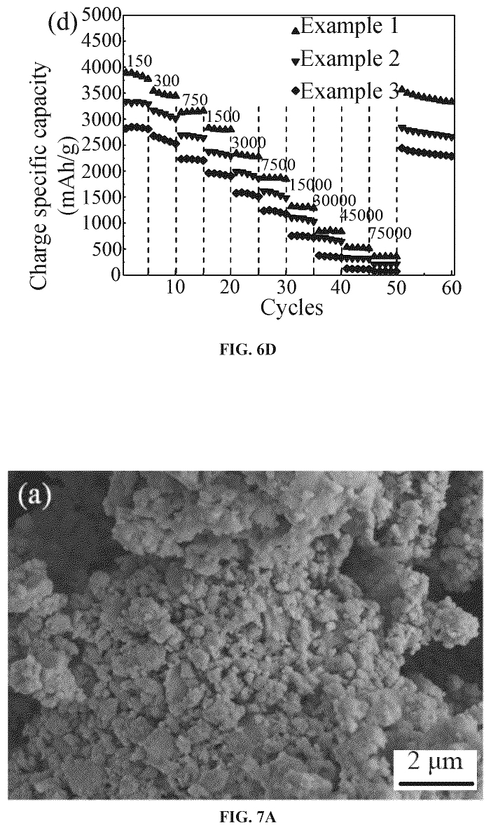

FIG. 6A to FIG. 6D show recycle performance curves of lithium-ion batteries assembled with the silicon-based anode materials prepared in Examples 1 to 3 at a current density of 300 mA/g (FIG. 6A), 1,500 mA/g (FIG. 6B), and 15,000 mA/g (FIG. 6C), and capacity curves (FIG. 6D) thereof at different current densities (mA/g).

In FIG. 6A to FIG. 6D, the first charge reversible specific capacity of the battery assembled in Example 1 at a current density of 300 mA/g is 3,660 mAh/g, the initial coulombic efficiency is 80.4%, and the capacity is retained at 3,063 mAh/g after 100 cycles, with a capacity retention rate of 83.7%. The first reversible capacity of the battery at a current density of 1,500 mA/g is 2,609 mAh/g, and the capacity is retained at 1,686 mAh/g after 500 cycles, with a capacity retention rate of 64.6%. The first reversible capacity of the battery at a current density of 15,000 mA/g is 1,467 mAh/g, and the capacity is retained at 432 mAh/g after 800 cycles, with a capacity retention rate of 29.4%. The specific capacities at different current densities of 150, 300, 750, 1,500, 3,000, 7,500, 15,000, 30,000, 45,000, and 75,000 mA/g are 3,852, 3,472, 3,142, 2,794, 2,295, 1,863, 1,304, 855, 523, and 357 mAh/g, respectively.

The first charge reversible specific capacity of the battery assembled in Example 2 at a current density of 300 mA/g is 3,253 mAh/g, the initial coulombic efficiency is 79.6%, and the capacity is retained at 2,432 mAh/g after 100 cycles, with a capacity retention rate of 74.8%. The first reversible capacity of the battery at a current density of 1,500 mA/g is 2,529 mAh/g, and the capacity is retained at 1,374 mAh/g after 500 cycles. The first reversible capacity of the battery at a current density of 15,000 mA/g is 1,332 mAh/g, and the capacity is retained at 269 mAh/g after 500 cycles. The specific capacities at different current densities of 150, 300, 750, 1,500, 3,000, 7,500, 15,000, 30,000, 45,000, and 75,000 mA/g are 3,335, 3,101, 2,681, 2,349, 1,955, 1,580, 1,090, 693, 324, and 211 mAh/g, respectively, showing excellent comprehensive electrochemical performances.

The electrochemical performance of the battery assembled in Example 3 was significantly lower than that in Examples 1 and 2.

By comparing the performance data of Example 1 with that of Example 2, it is found that as the In content increases, the electronic conductivity of the composite increases, which is beneficial to improving the electrochemical performance of the composite anode material. However, due to the excessive introduction of In, carrier transport is hindered, and thus its carrier mobility is reduced. Also, the particle size of the Si phase is increased, which is not conducive to the electrochemical properties of the composite.

By comparing the performance data of Example 2 with that of Example 3, it is found that, the electrochemical performance of the battery assembled in Example 3 is lower than that of Example 2, which is mainly because the Si phase particles formed in Example 3 are larger in size, and its carrier mobility and exchange current density are also lower than those in Example 2.

### Example 4

Step 1: a total of 100 g of silicon (Si) blocks (with a purity of greater than 99.9%) and tin (Sn) particles (with a purity of greater than 99.9 wt %) were weighed at a molar ratio of 97:3, put into a graphite crucible, and subjected to suspension induction melting under argon protection. The suspension induction melting was conducted at a power of 15 kW for 5 min. An ingot was obtained after the melting.
Step 2: the ingot was mechanically crushed, and a resulting powder sample was placed in a quartz tube. The quartz tube was placed in a vacuum rotary quenching furnace. A furnace chamber was first vacuumized, argon gas was then introduced thereto to 0.6 atmospheres, and suspension melting was conducted for 5 min. After the melt was completely melted, it was spray-casted onto a high-speed rotating copper roller through a nozzle with an argon gas flow of 1.7 atmospheres to allow rapid cooling, where a linear speed of the rotating copper roller was 30 m/s and a spray-casting distance was 2 m. After cooling, a rapidly-quenched product was collected and recorded as a Si/5 at % In composite.
Step 3: the rapidly-quenched product was ground with a sand mill. The grinding was conducted with anhydrous ethanol as a grinding medium using zirconium oxide grinding beads at a rotation speed of 1,200 rpm in the sand mill for 30 min. After drying, a Si-composited-with-In silicon-based composite was obtained.

FIG. 7A shows an SEM morphology image of the silicon-based composite finally prepared in this example, and FIG. 7B shows a TEM morphology image of the silicon-based composite finally prepared in this example. In FIG. 7A, the particle size of the silicon-based composite is at 300 nm to 1 μm, with a small portion slightly larger than 1 um. In silicon-based composite, the particle size of Si phase particles is relatively uniform, ranging from 200 nm to 300 nm. In FIG. 7B, within the white dotted lines are Si nanocrystal grains, indicating that Si phase particles are assembled from the Si nanocrystal grains, and the Si nanocrystal grains have a dimension of 20 nm to 30 nm. No Sn phase is observed by TEM, mainly because there is a small amount of Sn and Sn has a low melting point. During TEM observation, Sn is substantially melted and evaporated under the action of high-energy electron beam.

By tests, the silicon-based composite prepared in this example had a tap density of 0.98 g/mL and an electronic conductivity of 8.3×10-3 S/cm, and achieved a carrier mobility and an exchange current density of 378cm²/(V·s) and 43.6 mA/cm² , respectively.

### Example 5

In this example, the preparation process was substantially the same as that of Example 1, except that in step 1, a total of 100 g of the Si block and Sn particles were weighed at a molar ratio of 95:5.

SEM observation and analysis show that the particle size of the silicon-based composite prepared in this example is mainly in the range of 400 nm to 1 μm, with a small portion in the range of 1-2 μm, which is comparable to that in Example 4, indicating that the particle size of the composite is typical mechanically-crushed morphology. In silicon-based composite, the particle size of Si phase particles is also relatively uniform, ranging from 60 nm to 150 nm.

FIG. 8 shows the TEM morphology image of the silicon-based composite prepared in this example. The Si phase particles are assembled from Si nanocrystal grains, the Si nanocrystal grains having a dimension of 5 nm to 10 nm, and optionally a small amount of amorphous Si. No Sn phase is observed by TEM. Compared with Example 4, the dimension of Si nanocrystal grains in the final product prepared in this example is significantly reduced, which might be due to the increase in the linear speed of the rotating copper roller and the increase in the argon gas flow pressure in the nozzle that is used to transport the melt, which further refine the dimension of the nanocrystal grains in the Si phase particles.

By tests, the silicon-based composite prepared in this example had a tap density of 1.00 g/mL. The high tap density was beneficial to the improvement of the volume capacity density of the electrode and the battery. The silicon-based composite had an electronic conductivity of 0.249 S/cm, a carrier mobility of 9,850 cm² /(V·s), and an exchange current density of 85.3mA/cm².

### Example 6

In this example, the preparation process was substantially the same as that of Example 1, except that in step 1, a total of 100 g of the Si block and Sn particles were weighed at a molar ratio of 93:7.

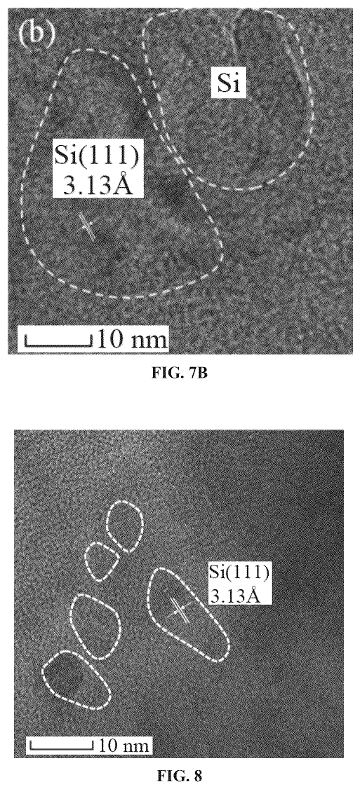

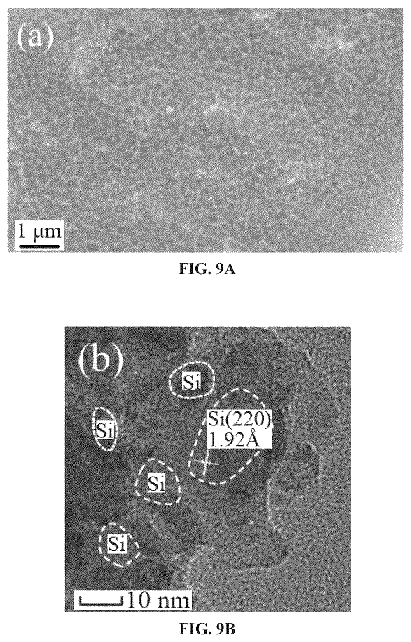

FIG. 9A shows an SEM morphology image of the rapidly-quenched product (Si/7 at % Sn composite) prepared in step 2 in this example, and FIG. 9B shows a TEM morphology image of the finally prepared silicon-based composite. In FIG. 9A, the dark phase is the Si phase, the light phase with a network structure is the Sn phase, and the particle size of the Si phase is uniform, mainly ranging from 80 nm to 200 nm. FIG. 9B shows that the Si phase particles are composed of a large number of Si nanocrystal grains with a dimension of 6 nm to 15 nm, and further optionally a small amount of amorphous silicon. The particle size of the silicon-based composite prepared in this example is mainly in the range of 400 nm to 1 μm, with a small portion in the range of 1-2 μm.

By tests, the silicon-based composite prepared in this example had a tap density of 1.06 g/mL and an electronic conductivity of 1.3 S/cm, and achieved a carrier mobility and an exchange current density of 4,870 cm² /(V·s) and 66.5 mA/cm², respectively.

### Example 7

Step 1: a total of 100 g of silicon (Si) blocks (with a purity of greater than 99.9%) and tin (Sn) particles (with a purity of greater than 99.9 wt %) were weighed at a molar ratio of 90:10, put into a graphite crucible to, and subjected to suspension induction melting under argon protection. The suspension induction melting was conducted at a power of 15 kW for 5 min. An ingot was obtained after the melting.

Step 2: the ingot was mechanically crushed, and a resulting powder sample was placed in a quartz tube. The quartz tube was placed in a vacuum rotary quenching furnace. A furnace chamber was first vacuumized, argon gas was then introduced thereto to 0.4 atmospheres, and suspension melting was conducted for 5 min. After the melt was completely melted, it was spray-casted onto a high-speed rotating copper roller through a nozzle with an argon gas flow of 1.5 atmospheres to allow rapid cooling, where a linear speed of the rotating copper roller was 30 m/s and a spray-casting distance was 1 m. After cooling, a rapidly-quenched product was collected and recorded as a Si/10 at % Sn composite.

Step 3: the rapidly-quenched product was ground with a sand mill. The grinding was conducted with anhydrous ethanol as a grinding medium using zirconium oxide grinding beads at a rotation speed of 1,000 rpm in the sand mill for 50 min. After drying, a Si-composited-with-In silicon-based composite was obtained.

FIG. 10A shows an SEM morphology image of the silicon-based composite prepared in this example, and FIG. 10B shows a TEM morphology image of the silicon-based composite prepared in this example. As shown in FIG. 10A, the particle size of the composite ranges from 400 nm to 1.5 μm, with a small part being in a range of 1-2 μm; the particle size of the Si phase particles is relatively large, ranging from 200 nm to 300 nm.

As shown in FIG. 10B, the dimension of Si nanocrystal grains in the Si phase particles ranges from 10 nm to 18 nm. Compared with Example 5, an increase in the dimension of Si nanocrystal grains in the Si phase particles is mainly due to the reduction in the linear speed of the rotating copper roller and the reduction in the argon gas flow pressure in the nozzle. In addition, the increase of Sn content might also causes that Si nanocrystal grains in Si phase particles become larger. This might be because as the Sn content increases, more Sn phase solidifies and releases more heat during the solidification, causing that Si nanocrystal grains grow larger.

By tests, the silicon-based composite prepared in this example had a tap density of 1.21 g/mL, and an electronic conductivity of 41.1 S/cm, and achieved a carrier mobility and an exchange current density of 521 cm²/(V·s) and 35.8 mA/cm², respectively.

FIG. 11 shows XRD patterns of the silicon-based composites prepared in Examples 4 to 7, respectively. It is found that the different silicon-based composites prepared in each example only contain Si (JCPDS27-1402) and Sn (JCPDS-04-0673) phases.

### Performance Testing

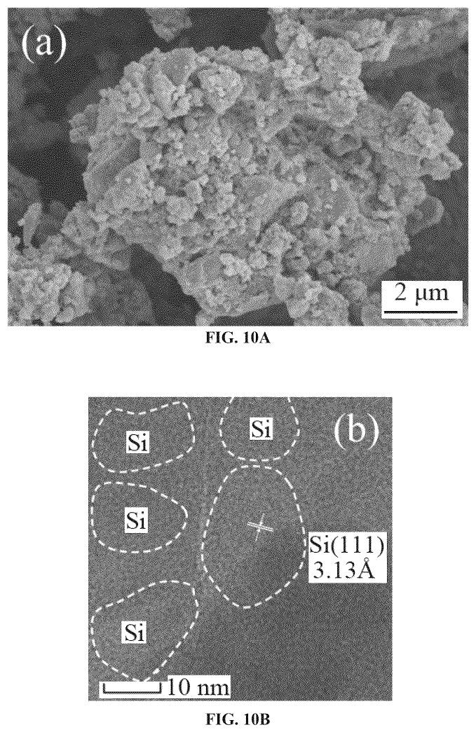

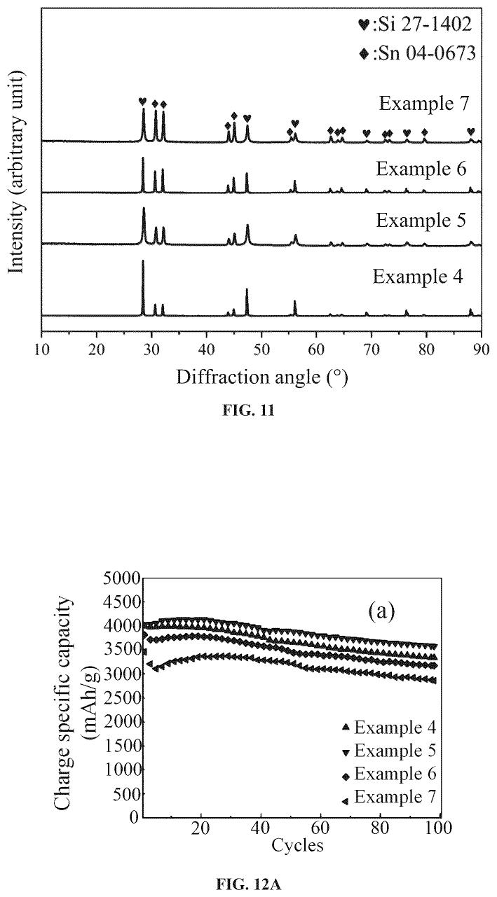

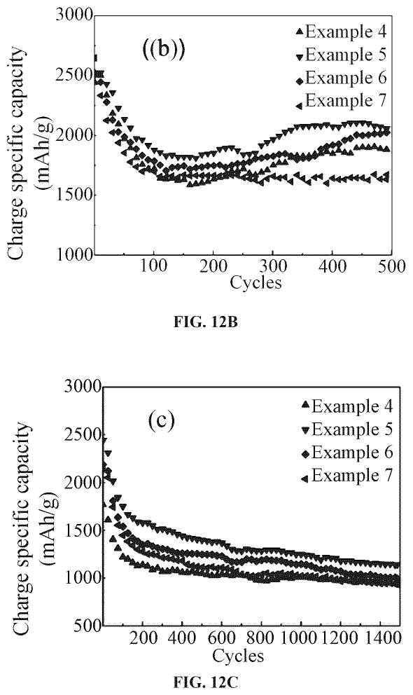

The silicon-based composites prepared in Examples 4 to 7 were used to assemble lithium-ion batteries in exactly the same manner as in Example 1. FIG. 12A to FIG. 12D show recycle performance curves of lithium-ion batteries assembled at a current density of 300 mA/g (FIG. 12A), 1,500 mA/g (FIG. 12B), and 15,000 mA/g (FIG. 12C); and capacity curves (FIG. 12D) thereof at different current densities (mA/g).

By tests, the first reversible capacity of the battery assembled in Example 4 at a current density of 300 mA/g was 4,001 mAh/g, the initial coulombic efficiency was 81.3%, and the capacity was retained at 3,337 mAh/g after 100 cycles, with a capacity retention rate of 83.4%. The first reversible capacity of the battery at a current density of 1,500 mA/g was 2,441 mAh/g, and the capacity was retained at 1,879 mAh/g after 500 cycles, with a capacity retention rate of 77.0%. The first reversible capacity of the battery at a current density of 15,000 mA/g was 1,766 mAh/g, and the capacity was retained at 950 mAh/g after 1,500 cycles. The specific capacities at different current densities of 150, 300, 750, 1,500, 3,000, 7,500, 15,000, 30,000, 45,000, and 75,000 mA/g were 4,329, 3,989, 3,448, 2,710, 2,228, 2,007, 1,697, 1,426, 1,180, and 563 mAh/g, respectively. It was seen that the silicon-based composite prepared in this example had excellent electrochemical properties.

The first reversible capacity of the battery assembled in Example 5 at a current density of 300 mA/g was 4,028 mAh/g, the initial coulombic efficiency was 82.5%, and the capacity was retained at 3,578 mAh/g after 100 cycles, with a capacity retention rate of 88.8%. The first reversible capacity of the battery at a current density of 1,500 mA/g was 2,501 mAh/g, and the capacity was retained at 2,059 mAh/g after 500 cycles, with a capacity retention rate of 82.3%. The first reversible capacity of the battery at a current density of 15,000 mA/g was 2,440 mAh/g, and the capacity was retained at 1,142 mAh/g after 1,500 cycles, with a capacity retention rate of 47%. The specific capacities at current densities of 150, 300, 750, 1,500, 3,000, 7,500, 15,000, 30,000, 45,000, and 75,000 mA/g were 4,224, 4,002, 3,695, 3,459, 3,156, 2,892, 2,431, 2,072, 1,689, and 1,254 mAh/g, respectively, showing excellent electrochemical performances.

The first reversible capacity of the battery assembled in Example 6 at a current density of 300 mA/g was 3,811 mAh/g, the initial coulombic efficiency was 81.4%, and the capacity was retained at 3,173 mAh/g after 100 cycles, with a capacity retention rate of 83.2%. The first reversible capacity of the battery at a current density of 1,500 mA/g was 2,521 mAh/g, and the capacity was retained at 2,021 mAh/g after 500 cycles, with a capacity retention rate of 80.2%. The first reversible capacity of the battery at a current density of 15,000 mA/g was 2,187 mAh/g, and the capacity was retained at 995 mAh/g after 1,500 cycles, with a capacity retention rate of 45.5%. The specific capacities at different current densities of 150, 300, 750, 1,500, 3,000, 7,500, 15,000, 30,000, 45,000, and 75,000 mA/g were 4,010, 3,876, 3,662, 3,412, 3,039, 2,763, 2,280, 1,882, 1,502, and 930 mAh/g, respectively. The composite exhibited excellent comprehensive electrochemical performances.

The electrochemical performance of the battery assembled in Example 7 was generally inferior to those of Examples 4 to 6.

### Example 8

In this example, the preparation process was substantially the same as that of Example 1, except that in step 1, a total of 100 g of the Si block and silver (Ag) particles each with purity greater than 99.9% were weighed at a molar ratio of 95:5.

By tests, the electronic conductivity of the composite finally prepared in this example was 4.3×10⁻² S/cm, which was more than 5 times lower than that of the silicon-based composite with the same Sn molar fraction (Example 5), but the conductivity of elemental Ag was almost one order of magnitude higher than that of elemental Sn. This might be because although the melting point of Ag was lower than that of Si, its melting point was 961 ° C., resulting in that there was a difference of about 453° C. relative to the melting point of Si, which was significantly smaller compared with the temperature difference between the melting point of Sn (a melting point of 232° C., and there being a difference of 1,182 C. relative to the melting point of Si) and the melting point of Si.

This might result in that during the rapid solidification of rapid quenching, part of the Ag and Si solidified almost simultaneously and then formed a particle distribution with the Si phase, failing to fully form a network structure to exert its conductive network structure and cover the Si particles. Therefore, there was a weakened effect on improving the electrochemical performance of Si-based material.

### Example 9

In this example, the preparation process was substantially the same as that of Example 5, except that in step 1, a total of 100 g of the Si block, Sn particles, and In powder were weighed at a molar ratio of 92:5:3.

Characterization showed that the particle size of the silicon-based composite prepared in this example was mainly in the range of 300 nm to 1 um, and the particle size of Si phase ranged from 80 nm to 150 nm.

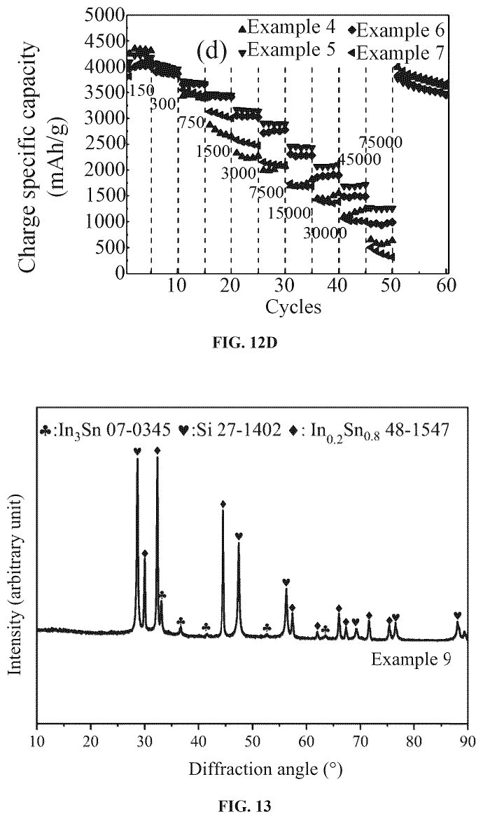

FIG. 13 shows the XRD pattern of the silicon-based composite prepared in this example. By tests, the silicon-based composite contains Si, In_{0.2}Sn_{0.8} (JCPDS 48-1547), and In₃Sn (JCPDS 07-0345) phases. Although Sn reacted with In to form a compound, its melting point was lower than that of Sn. Therefore, during the rapid cooling of the spinning belt, In_{0.2}Sn_{0.8} and In₃Sn phases still solidified later than Si and thus existed between Si particles after cooling.

By tests, the silicon-based composite prepared in this example had a tap density of 0.91 g/mL, an electronic conductivity of 108 S/cm, and achieved a carrier mobility and an exchange current density of 1,010cm²/(V·s) and 5.922mA/cm², respectively.

### Performance Testing

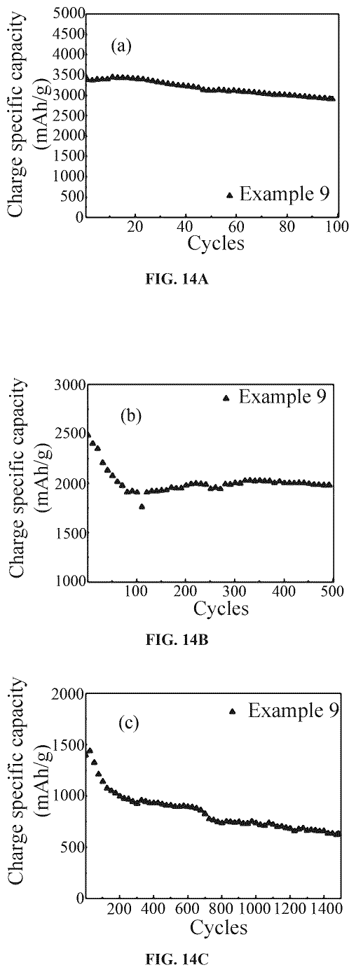

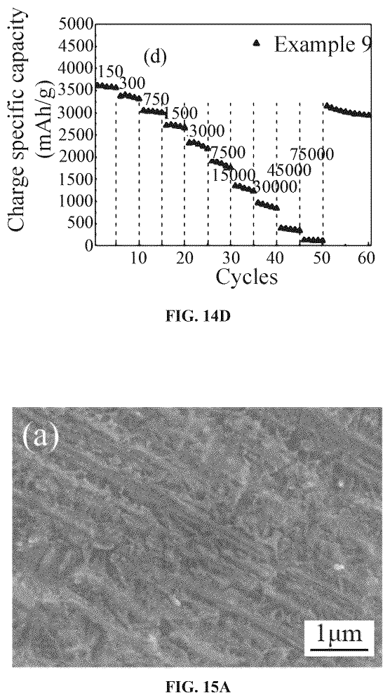

The silicon-based composite prepared in Example 9 was used to assemble lithium-ion batteries in exactly the same manner as in Example 1. FIG. 14A to FIG. 14D show recycle performance curves of the battery assembled at a current density of 300 mA/g (FIG. 14A), 1,500 mA/g (FIG. 14B), and 15,000 mA/g (FIG. 14C); and capacity curves (FIG. 14D) thereof at different current densities (mA/g).

By tests, the first reversible capacity of the battery assembled in Example 9 at a current density of 300 mA/g was 3,395 mAh/g, the initial coulombic efficiency was 81.7%, and the capacity was retained at 2,910 mAh/g after 100 cycles, with a capacity retention rate of 85.7%. The first reversible capacity of the battery at a current density of 1,500 mA/g was 2,489 mAh/g, and the capacity was retained at 1,983 mAh/g after 500 cycles, with a capacity retention rate of 79.7%. The first reversible capacity of the battery at a current density of 15,000 mA/g was 1,399 mAh/g, and the capacity was retained at 632 mAh/g after 1,500 cycles. The specific capacities at different current densities of 150, 300, 750, 1,500, 3,000, 7,500, 15,000, 30,000, 45,000, and 75,000 mA/g were 3,581, 3,374, 3,033, 2,714, 2,288, 1,851, 1,296, 902, 375, and 120 mAh/g, respectively. The composite anode material exhibited excellent electrochemical performances.

### Example 10

In this example, the preparation process was substantially the same as that of Example 1, except that in step 1, a total of 100 g of the Si block, germanium powder (Ge, purity not less than 99.9%), and Sn particles were weighed at a molar ratio of 92:3:5.

### Example 11

In this example, the preparation process was substantially the same as that of Example 1, except that in step 1, a total of 100 g of the Si block, germanium powder (Ge, purity not less than 99.9%), and Sn particles were weighed at a molar ratio of 90:5:5.

### Example 12

In this example, the preparation process was substantially the same as that of Example 1, except that in step 1, a total of 100 g of the Si block, germanium powder (Ge, purity not less than 99.9%), and Sn particles were weighed at a molar ratio of 88:7:5.

### Example 13

In this example, the preparation process was substantially the same as that of Example 1, except that in step 1, a total of 100 g of the Si block, germanium powder (Ge, purity not less than 99.9%), and Sn particles were weighed at a molar ratio of 85:10:5.

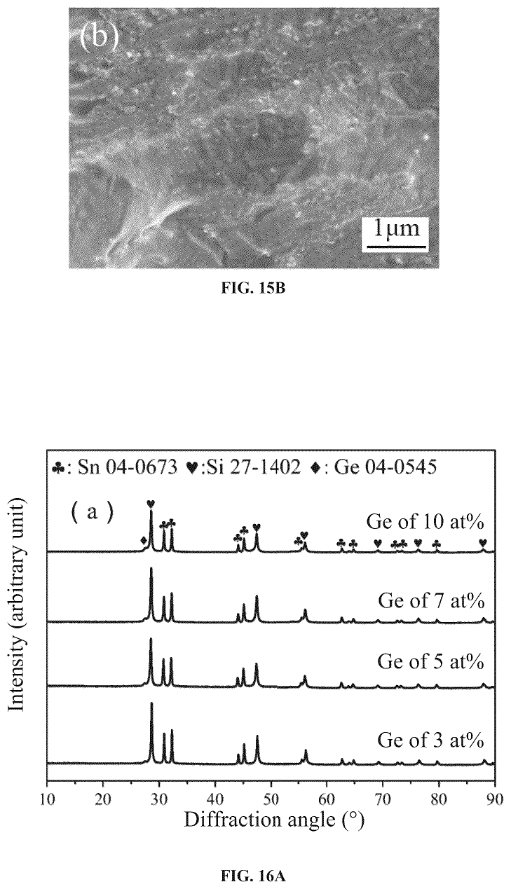

FIG. 15A shows an SEM image of the rapidly-quenched products prepared in step 2 of Example 11 and FIG. 15B shows an SEM image of the rapidly-quenched products prepared in step 2 of Example 13. As shown in FIG. 15A and FIG. 15B, after rapid quenching, the surface of the product is relatively uniform and dense without obvious particle coarsening or grain boundary precipitation. The particle size of the Si-Ge composite phase in the rapidly-quenched product in Example 11 ranges from 60 nm to 120 nm, and for Example 13, it ranges from 100 nm to 200 nm.

FIG. 16A shows XRD patterns of the silicon-based composites prepared in Examples 10 to 13, respectively. XRD analysis shows that the product is mainly composed of Si phase, Sn phase, and a small amount of Ge phase (JCPDS 04-0545). Since the diffraction peak of Ge is highly close to the main strong peak of Si, its diffraction peak is easily masked by that of the Si phase when the Ge content is low. When the Ge content reaches 7 mol % and 10 mol %, a weak Ge diffraction peak could be seen at 27.5°. Although Si and Ge form an infinite solid solution at a thermodynamic equilibrium state, there is not enough time for forming solid solution between Ge and Si, and a small amount of single Ge precipitates because the cooling rate is extremely high during the rapid quenching, and the Si-Ge liquidus and solidus are highly different due to the difference in melting points between Ge and Si and the increase in Ge content. At low Ge content, Ge is relatively prone to forming solid solution. XRD analysis shows that in this example, as the amount of Ge added in the composite increases, the diffraction peak of Si shifts to a smaller angle, indicating that part of Ge forms a solid solution with Si. The enlarged view of the diffraction peak of the (422) crystal plane of Si in FIG. 16B clearly reveals the left shift of the peak position, indicating that its crystal plane spacing increases; the more Ge added results in a more peak position shift, indicating more Ge forms solid solution. After forming Si-Ge solid solution, the lattice constant of Si become larger due to the solid solution of Ge, which is beneficial to the deintercalation of lithium ions and thus to the improvement of its kinetic performance.

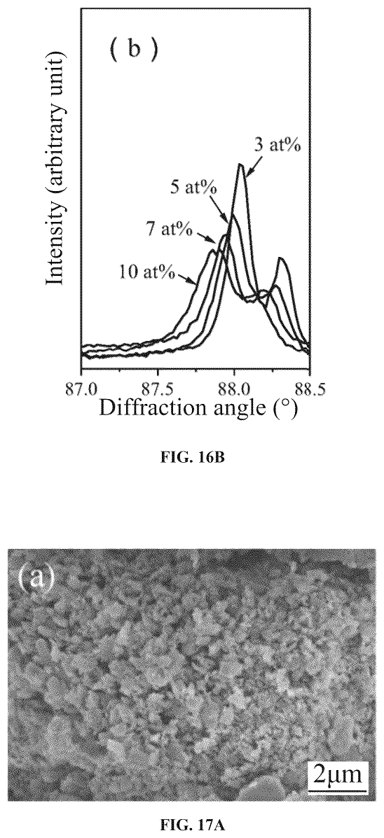

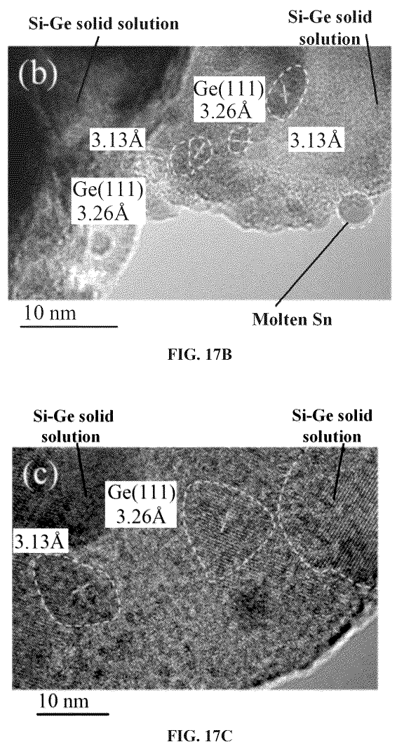

FIG. 17A shows an SEM morphology image of the silicon-based composite prepared in Example 11, and FIG. 17B shows a TEM morphology image of the silicon-based composite prepared in Example 11, and FIG. 17C shows a TEM morphology image of the silicon-based composite prepared in Example 13. As show in FIG. 17A to FIG. 17C, the Si-Ge composite phase is composed of Si-Ge solid solution nanocrystal grains and a small amount of Ge nanocrystal grains. In the silicon-based composite prepared in Example 11, the grain size of the Si-Ge solid solution nanocrystal grains and Ge in the Si-Ge composite phase ranges from 3 nm to 5 nm. In the silicon-based composite prepared in Example 13, the grain size of the Si-Ge solid solution nanocrystal grains and Ge in the Si-Ge composite phase ranges from 5 nm to 10 nm. The relatively low Ge content in the silicon-based composite is beneficial to the reduction on the dimension of nanocrystal grains in the Si-Ge composite phase. It is worth noting that due to the low melting point of Sn, it might melt under the irradiation of high-energy electron beam to form obvious droplets as shown in FIG. 17B, so it is difficult to be directly observed by TEM. In addition, due to the segregation of the Si-Ge solid solution phase, local Ge segregation occurs at the microscopic level, forming a small amount of Ge nanocrystal grains. Although Ge does not fully dissolve in Si, which does not fully play its role in increasing the Si interplanar spacing and thus promoting the intercalation and deintercalation of lithium ions, its relatively high electronic conductivity and ion diffusion ability compared with Si still provide beneficial effects on the electrochemical properties of Si.

By tests, the tap density of each silicon-based composite prepared in Examples 10 to 13 ranged from 0.87 g/mL to 0.9 g/mL, and the more Ge added resulted in a higher tap density. High tap density was beneficial to the improvement of volume capacity density of electrodes and batteries.

By tests, the electronic conductivity of each silicon-based composite prepared in Examples 10 to 13 ranged from 2.5 to 3.9 S/cm, which was nearly 5 orders of magnitude higher than that of the products prepared in Comparative Examples 1 and 2.

The carrier mobility and exchange current density of the silicon-based composites prepared in Examples 10 to 13 were 6,970, 18,900, 14,300, and 8,680 cm²/(V·s) and 60.53, 79.43, 65.46, and 45.71 mA/cm², respectively, which were significantly higher than the corresponding values of Comparative Examples 1 and 2, and thereby were beneficial to improving the comprehensive electrochemical properties of the composite.

### Performance Testing

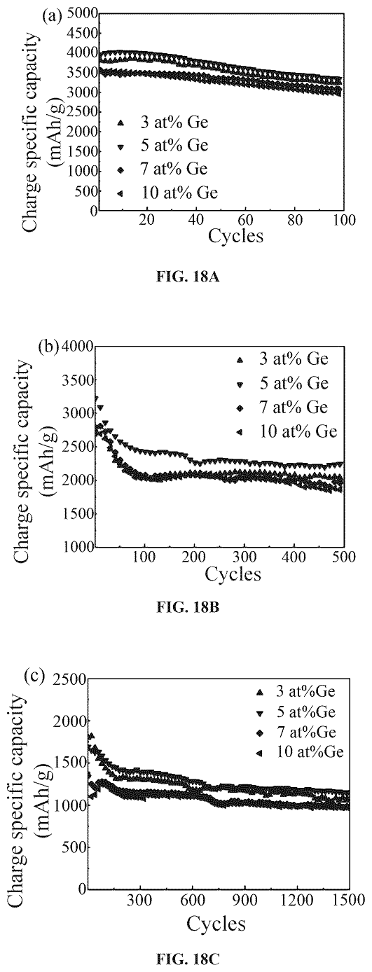

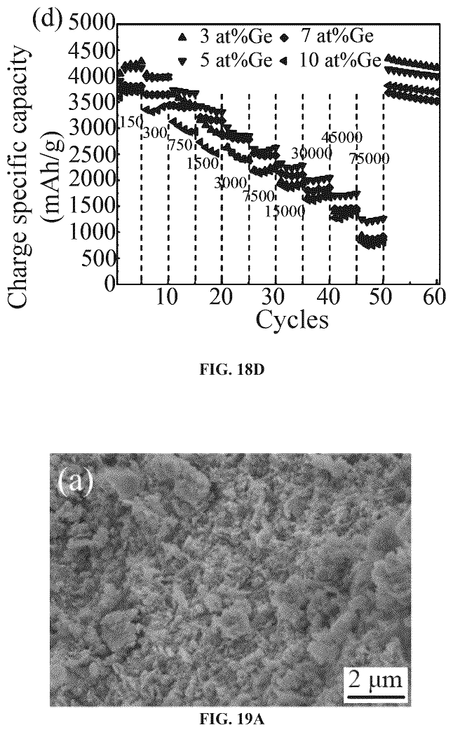

The silicon-based composites prepared in Examples 10 to 13 were separately used to assemble lithium-ion batteries in exactly the same manner as in Example 1. FIG. 18A to FIG. 18D show recycle performance curves of batteries assembled at a current density of 300 mA/g (FIG. 18A), 1,500 mA/g (FIG. 18B), and 15,000 mA/g (FIG. 18C), and capacity curves thereof at different current densities (mA/g).

In FIG. 18A to FIG. 18D, the Si—Ge/5 at % Sn composite with a Ge addition of 5 at % (Example 11) had the best comprehensive electrochemical performance. The first reversible capacity of the battery at a current density of 300 mA/g was 3,953 mAh/g, the initial coulombic efficiency was 81.4%, and the capacity was retained at 3,343 mAh/g after 100 cycles, with a capacity retention rate of 84.5%. The first discharge capacity of the battery at a current density of 1,500 mA/g was 3,222 mAh/g, and the capacity was retained at 2,244 mAh/g after 500 cycles, with a capacity retention rate of 69.6%. The first discharge capacity of the battery at a current density of 15,000 mA/g was 1,692 mAh/g, and the capacity was retained at 1,145 mAh/g after 1,500 cycles, with a capacity retention rate of 67.7%. In terms of capacity retention rate alone, the silicon-based composite prepared with a Si:Ge:Sn molar ratio of 88:7:5 (Example 12) had a capacity of 980 mAh/g after 1,500 cycles, with a capacity retention rate of 72.6%, which was higher than those of all previous examples. However, the capacity was slightly lower than that of the silicon-based composite prepared in Example 11.

The reversible specific capacities of the silicon-based composite prepared in Example 11 at different current densities of 150, 300, 750, 1,500, 3,000, 7,500, 15,000, 30,000, 45,000, and 75,000 mA/g were 4,167, 3,982, 3,697, 3,358, 2,863, 2,556, 2,238, 2,009, 1,706, and 1,225 mAh/g, respectively. The introduction of Ge greatly improved the electronic conductivity and lithium ion mobility of the composite. The carrier mobility of the silicon-based composite prepared in Example 11 was as high as 18,900 cm 2/(V·s), which played an important role in the excellent recycle performance of the material in this example, especially the recycle performance at high rates.

### Comparative Example 1

In this comparative example, the preparation process was substantially the same as that of Example 1, except that in 1, only 100 g of silicon blocks as raw material sample were placed in the graphite crucible.

### Comparative Example 2

In this comparative example, the preparation process was substantially the same as that of Example 1, except that rapid quenching in 2 was not conducted, that was to say, the ingot was directly crushed and then sand-milled.

FIG. 19A and FIG. 19B show SEM morphology images of the final products prepared in Comparative Example 1 (FIG. 19A) and Comparative Example 2 (FIG. 19B), respectively. In FIG. 19A, the particle size of the product ranged from a few hundred nm to 1 μm, with a small portion being in a range of 1-2 μm; in FIG. 19B, the particle size of the product ranged from a submicron level to a micron level, with a small portion being in a range of 1-2 μm.

XRD test shows that the products prepared in Comparative Example 1 and Comparative Example 2 only contained Si phase. The diffraction peak intensity of Si in Comparative Example 2 was higher than that in Comparative Example 1, because the rapid quenching reduced the crystallinity of the material.

By tests, the product prepared in Comparative Example 1 had a tap density of 0.66 g/mL and an electronic conductivity of 9.3×10⁻⁵ S/cm, and achieved a carrier mobility and an exchange current density of 2.1 cm²/(V·s) and 3.3×10⁻³ mA/cm², respectively.

The product prepared in Comparative Example 2 had a tap density of 0.65 g/mL and an electronic conductivity of 6.7×10⁻⁵ S/cm, and achieved a carrier mobility and an exchange current density of 1.24 cm²/(V·s) and 8.2×10⁻⁴ mA/cm², respectively.

### Performance Testing

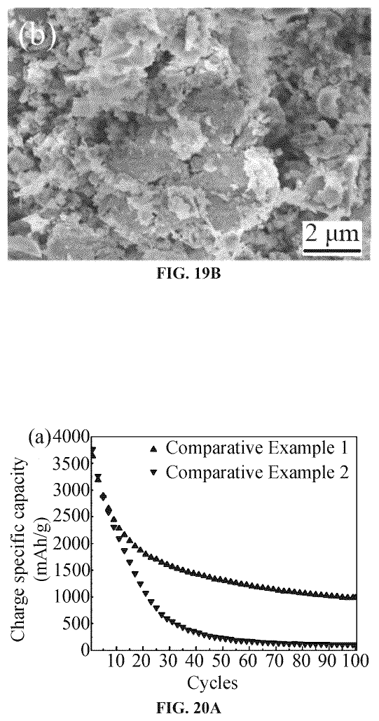

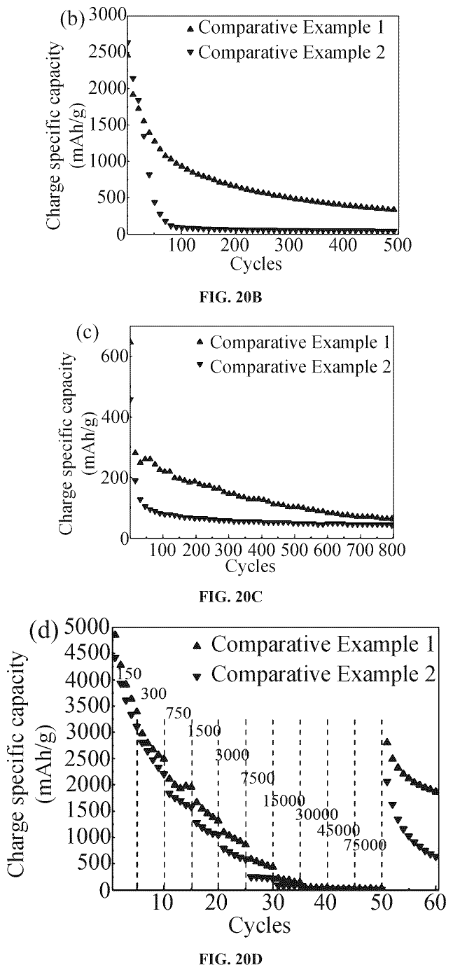

The products prepared in Comparative Examples 1 to 2 were used to assemble lithium-ion batteries in exactly the same manner as in Example 1. FIG. 20A to FIG. 20D show recycle performance curves of batteries assembled at a current density of 300 mA/g (FIG. 20A), 1,500 mA/g (FIG. 20B), and 15,000 mA/g (FIG. 20C), and capacity curves (FIG. 20D) thereof at different current densities (mA/g).

By tests, the first reversible capacity of the battery assembled in Comparative Example 1 at a current density of 300 mA/g was 3,631 mAh/g, the initial coulombic efficiency was 77.9%, and the capacity was retained at 986 mAh/g after 100 cycles, with a capacity retention rate of 27.2%. The first reversible capacity of the battery at a current density of 1,500 mA/g was 2,454 mAh/g, and the capacity was retained at 330 mAh/g after 500 cycles, with a capacity retention rate of 13.4%. The first reversible capacity of the battery at a current density of 15,000 mA/g was 646 mAh/g, and the capacity was retained at 61 mAh/g after 800 cycles. The specific capacities at different current densities of 150, 300, 750, 1,500, 3,000, 7,500, 15,000, 30,000, 45,000, and 75,000 mA/g were 3,906, 2,671, 1,930, 1,457, 971, 503, 185, 42, 21, and 15 mAh/g, respectively. In the later stage of high current discharge, the anode material obtained in this comparative example had completely lost its electrochemical activity.

The first reversible capacity of the battery assembled in Comparative Example 2 at a current density of 300 mA/g was 3,765 mAh/g, the initial coulombic efficiency was 80.0%, and the capacity was retained at 109 mAh/g after 100 cycles, with a capacity retention rate of 2.9%. The first reversible capacity of the battery at a current density of 1,500 mA/g was 2,631 mAh/g, and the capacity was retained at 47 mAh/g after 500 cycles, with a capacity retention rate of 1.8%. The first reversible capacity of the battery at a current density of 15,000 mA/g was 458 mAh/g, and the capacity was retained at 45 mAh/g after 800 cycles. The specific capacities at different current densities of 150, 300, 750, 1,500, 3,000, 7,500, 15,000, 30,000, 45,000, and 75,000 mA/g were 3,613, 2,483, 1,694, 1,123, 668, 243, 85, 34, 14, and 9 mAh/g, respectively. The electrochemical performance of the anode material obtained in this comparative example was significantly lower than that of Comparative Example 1, and the anode material lost its electrochemical activity soon as the cycle proceeded.

Comparative Example 3

In this comparative example, the preparation process was substantially the same as that of Example 6, except that in step 1, a total of 100 g of the Si block and chromium powder (Cr, melting point of 1,907° C.) each with purity greater than 99.9% were weighed at a molar ratio of 93:7.

By tests, the electronic conductivity of the silicon-based composite prepared in this comparative example was 0.25 S/cm. Compared with the systems of other examples of the present disclosure with the same molar fraction, the electronic conductivity was significantly lower.

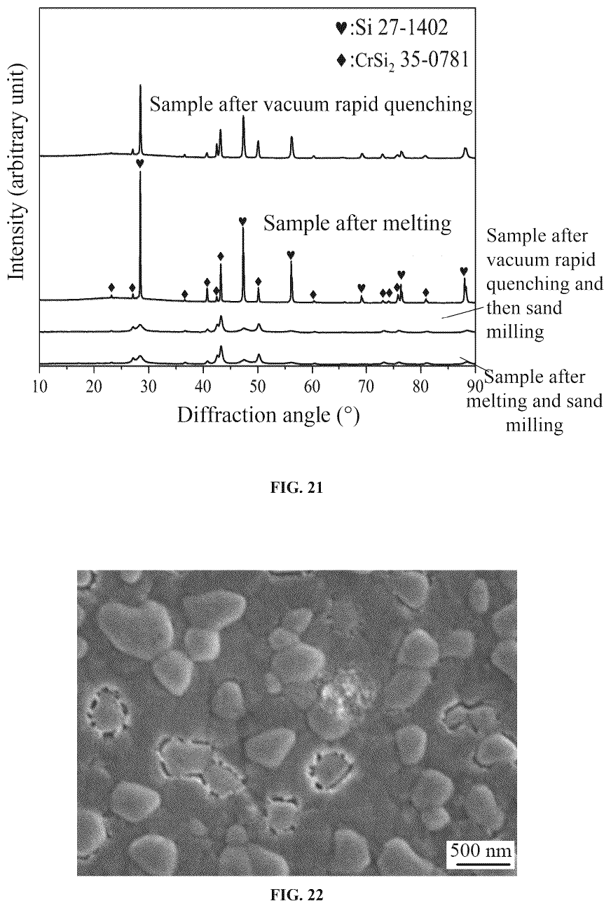

The silicon-based composite finally prepared in this comparative example was subjected to XRD analysis. As shown in FIG. 21, in the final product, a CrSi₂ phase (JCPDS 35-0781) was formed, and the rest was a Si phase.

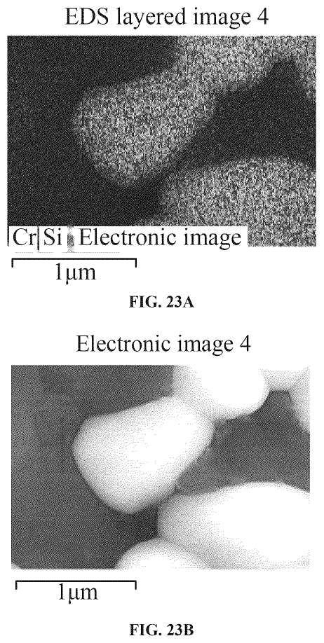

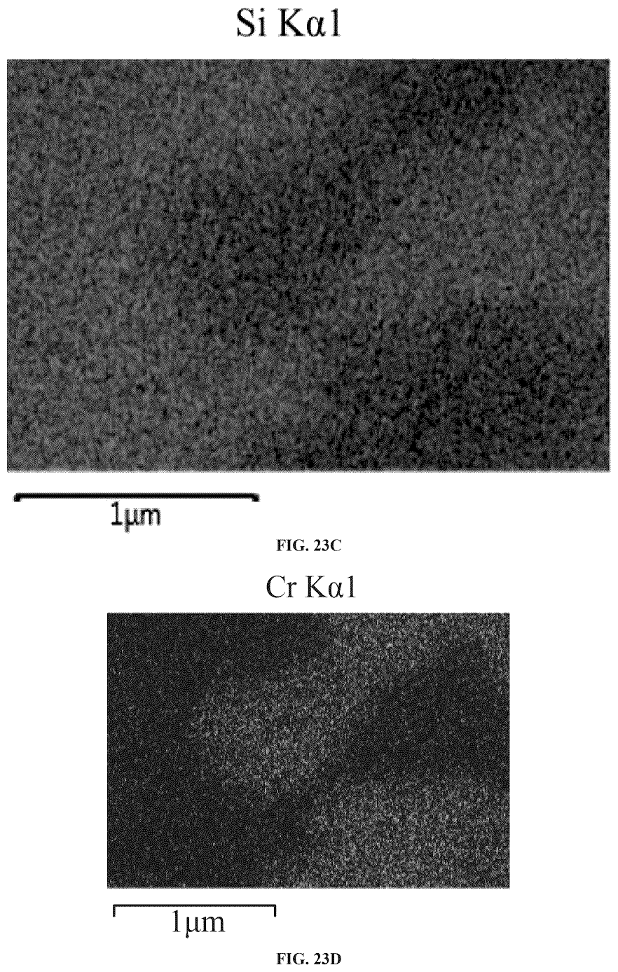

The rapidly-quenched product prepared in step 2 was observed and analyzed by BSE-SEM and EDS. In the BSE morphology image of FIG. 22, the light-colored particle phase is the CrSi₂ phase, and the dark-colored matrix phase is the Si phase. CrSi₂ precipitates in granular form in the Si matrix, and the size of CrSi₂ particles ranges from 200 nm to 500 nm. As shown in the EDS of FIG. 23A to FIG. 23D, both the melting point of Cr (1,907° C.) and the melting point of the formed CrSi₂ phase (slightly higher than 1,500° C., obtained from the Cr-Si phase diagram) are higher than the melting point of Si. Therefore, during the rapid quenching and condensation, the CrSi₂ phase solidifies first, and the later solidified Si phase exists among the CrSi₂ particles, such that the conductive network of the Cr phase or CrSi₂ could not be formed.

### Performance Testing

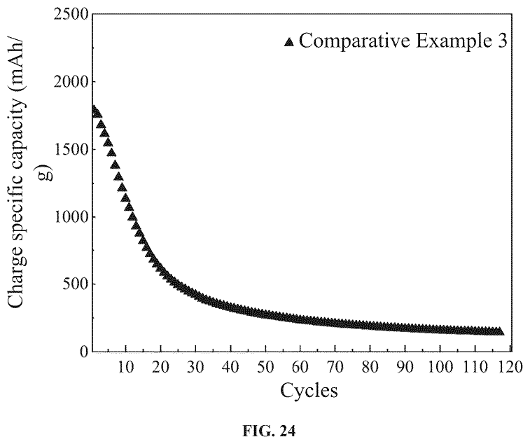

The silicon-based composite prepared in Comparative Example 3 was used to assemble lithium-ion batteries in exactly the same manner as in Example 1. FIG. 24 shows recycle performance curve of batteries assembled at a current density of 300 mA/g. By tests, it was found that the capacity of the battery assembled in this comparative example declined rapidly during the cycle. Isolated distribution of CrSi₂ had no effect on improving the recycle performance of the composite.

The above description only shows specific embodiments of the present disclosure, but the scope of the present disclosure is not limited thereto. The above specific examples are used to illustrate the present disclosure, which is only used to help understand the present disclosure and is not used to limit the present disclosure. Those skilled in the art to which the present disclosure belongs may also make some simple deductions, modifications, substitutions, or combinations based on the concepts of the present disclosure. These deductions, modifications, substitutions, or combinations also fall within the scope of the claims of the present disclosure.

1. A silicon-based composite of a silicon-based phase composited with metal phases, wherein the silicon-based phase is assembled from silicon-based nanocrystal grains, an outer surface of the silicon-based phase is coated with metal phases, and the metal phases form a spatial network structure by interconnecting with each other;
the silicon-based phase comprises one selected from the group consisting of a single silicon phase and a Si—Ge composite phase;
under the condition that the silicon-based phase is the single silicon phase, the silicon-based nanocrystal grains are silicon nanocrystal grains;
under the condition that the silicon-based phase is the Si—Ge composite phase, the silicon-based nanocrystal grains are Si-Ge nanocrystal grains; and
the metal phases each have a melting point lower than a melting point of the silicon-based phase.

2. The silicon-based composite of the silicon-based phase composited with the metal phases as claimed in claim 1, wherein the silicon-based nanocrystal grains each have a dimension of 2 nm to 200 nm;
the silicon-based phase has a size of 10 nm to 1,000 nm; and
the silicon-based composite has a size of 200 nm to 5 μm.

3. The silicon-based composite of the silicon-based phase composited with the metal phases as claimed in claim 1, wherein a metal in the metal phases is at least one selected from the group consisting of Sn, In, Al, Pb, Zn, Sb, Bi, Se, and Ag.

4. The silicon-based composite of the silicon-based phase composited with the metal phases as claimed in claim 1, wherein a metal in the metal phases is at least one selected from the group consisting of Sn and In.

5. The silicon-based composite of the silicon-based phase composited with the metal phases as claimed in claim 1, wherein a metal in the metal phases is Sn.

6. The silicon-based composite of the silicon-based phase composited with the metal phases as claimed in claim 1, wherein
a temperature difference AT in a melting point between the silicon-based phase and the metal phases is not less than 500° C.

7. The silicon-based composite of the silicon-based phase composited with the metal phases as claimed in claim 1, wherein
the silicon-based nanocrystal grains each have a dimension of 2 nm to 50 nm;
the silicon-based phase has a size of 10 nm to 800 nm; and
the silicon-based composite has a size of 300 nm to 3 μm.

8. The silicon-based composite of the silicon-based phase composited with the metal phases as claimed in claim 1, wherein
the silicon-based nanocrystal grains each have a dimension of 2 nm to 30 nm;
the silicon-based phase has a size of 30 nm to 300 nm; and
the silicon-based composite has a size of 300 nm to 1.5 μm.

9. A method for preparing the silicon-based composite of the silicon-based phase composited with the metal phases as claimed in claim 1, comprising:
step 1, mixing a silicon-based raw material and a metal raw material, and subjecting a resulting mixture to suspension induction melting in an argon atmosphere to obtain a silicon-based composite ingot, the silicon-based raw material being selected from the group consisting of Si and a mixture of Si and Ge;
step 2, crushing the silicon-based composite ingot into a powder, placing the powder in a vacuum rotary quenching furnace, and subjecting the powder to suspension melting in an argon atmosphere; transferring a resulting melt through a nozzle carrying an argon gas flow, and spray-casting the resulting melt onto a rotating copper roller, then cooling and collecting a resulting rapidly-quenched product; and
step 3, subjecting the rapidly-quenched product to sand-milling to obtain the silicon-based composite of the silicon-based phase composited with the metal phases.

10. The method for preparing the silicon-based composite of the silicon-based phase composited with the metal phases as claimed in claim 9, wherein the metal raw material is at least one selected from the group consisting of Sn, In, Al, Pb, Zn, Sb, Bi, Se, and Ag.

11. The method for preparing the silicon-based composite of the silicon-based phase composited with the metal phases as claimed in claim 9, wherein in step 1,
a molar ratio of the silicon-based raw material to the metal raw material is in a range of 1:0.01 to 1:0.3; and
under the condition that the silicon-based raw material is the mixture of Si and Ge, a molar ratio of the Si to the Ge is in a range of 1:0.01 to 1:0.5.

12. The method for preparing the silicon-based composite of the silicon-based phase composited with the metal phases as claimed in claim 9, wherein in step 1,
a molar ratio of the silicon-based raw material to the metal raw material is in a range of 1:0.03 to 1:0.11.

13. The method for preparing the silicon-based composite of the silicon-based phase composited with the metal phases as claimed in claim 9, wherein in step 1,
a molar ratio of the silicon-based raw material to the metal raw material is in a range of 1:0.03 to 1:0.08.

14. The method for preparing the silicon-based composite of the silicon-based phase composited with the metal phases as claimed in claim 9, wherein in step 1,
a molar ratio of the silicon-based raw material to the metal raw material is in a range of 1:0.05.

15. The method for preparing the silicon-based composite of the silicon-based phase composited with the metal phases as claimed in claim 9, wherein in step 1, under the condition that the silicon-based raw material is the mixture of Si and Ge, a molar ratio of the Si to the Ge is in a range of 1:0.03 to 1:0.12.

16. The method for preparing the silicon-based composite of the silicon-based phase composited with the metal phases as claimed in claim 9, wherein in step 1, under the condition that the silicon-based raw material is the mixture of Si and Ge, a molar ratio of the Si to the Ge is in a range of 1:0.03 to 1:0.08.

17. The method for preparing the silicon-based composite of the silicon-based phase composited with the metal phases as claimed in claim 9, wherein in step 1, under the condition that the silicon-based raw material is the mixture of Si and Ge, a molar ratio of the Si to the Ge is in a range of 1:0.05 to 1:0.06.

18. The method for preparing the silicon-based composite of the silicon-based phase composited with the metal phases as claimed in claim 9, wherein in step 2,
the argon gas flow has a pressure of 0.4 to 4.0 atmospheres; and
the rotating copper roller has a linear speed of 10 m/s to 100 m/s.

19. The method for preparing the silicon-based composite of the silicon-based phase composited with the metal phases as claimed in claim 9, wherein the spray-casting in step 2 is conducted at a distance of 0.5 m to 2.5 m.

20.-23 (canceled)

24. A lithium-ion battery, comprising a cathode, an anode, a separator, and an electrolyte, wherein an active material of the anode comprises the silicon-based composite of the silicon-based phase composited with the metal phases as claimed in claim 1.

25. (canceled)
